(19) United States
(12) Patent Application Publication
(10) Pub. No.: US 2010/0153185 A1
(43) Pub. Date: Jun. 17, 2010

(54) MEDIATING AND PRICING TRANSACTIONS BASED ON CALCULATED REPUTATION OR INFLUENCE SCORES

(75) Inventors: Rishab Aiyer Ghosh, Brussels (BE); Vipul Ved Prakash, San Francisco, CA (US)

Correspondence Address: VAN PELT, YI & JAMES LLP, 10050 N. FOOTHILL BLVD #200, CUPERTINO, CA, 95014, US

(73) Assignee: Topsy Labs, Inc., San Francisco, CA (US)

(21) Appl. No.: 12/628,814

(22) Filed: Dec. 1, 2009

Related U.S. Application Data
(60) Provisional application No. 61/200,658, filed on Dec. 1, 2008.

(51) Int. Cl. G06Q 10/00; G06Q 99/00; G06Q 30/00

(52) U.S. Cl. 705/10; 705/400; 705/1.1; 705/14.16; 705/319

(57) ABSTRACT

Mediating and pricing transactions based on calculated reputation and influence is provided. In some embodiments, mediating and pricing transactions based on calculated reputation and influence includes determining an influence score (e.g., based on a given dimension) for a subject (e.g., a user), in which the subject is requesting a transaction; and determining approval of the transaction based on criteria including the influence score of the subject. In some embodiments, the influence score is a directly estimated objective measure of influence (e.g., estimated using a social graph). In some embodiments, mediating and pricing transactions based on calculated reputation and influence further includes determining pricing of the transaction based on criteria including the influence score of the subject. In some embodiments, mediating and pricing transactions based on calculated reputation and influence also includes sharing transactional revenue for the transaction with the subject based on criteria including the influence score of the subject.

### CROSS REFERENCE TO OTHER APPLICATIONS

This application claims priority to U.S. Provisional Patent Application No. 61/200,658 (Attorney Docket No. UPBEP007+) entitled SYSTEM AND METHOD OF MEDIATING AND PRICING TRANSACTIONS BASED ON CALCULATED REPUTATION OR INFLUENCE SCORES filed Dec. 1, 2008, which is incorporated herein by reference for all purposes.

### BACKGROUND OF THE INVENTION

Knowledge is increasingly more germane to our exponentially expanding information-based society. Perfect knowledge is the ideal that participants seek to assist in decision making and for determining preferences, affinities, and dislikes. Practically, perfect knowledge about a given topic is virtually impossible to obtain unless the inquirer is the source of all of information about such topic (e.g., autobiographer). Armed with more information, decision makers are generally best positioned to select a choice that will lead to a desired outcome/result (e.g., which restaurant to go to for dinner). However, as more information is becoming readily available through various electronic communications modalities (e.g., the Internet), one is left to sift through what is amounting to a myriad of data to obtain relevant and, more importantly, trust worthy information to assist in decision making activities. Although there are various tools (e.g., search engines, community boards with various ratings), there lacks any indicia of personal trustworthiness (e.g., measure of the source's reputation and/or influence) with located data.

### BRIEF DESCRIPTION OF THE DRAWINGS

Various embodiments of the invention are disclosed in the following detailed description and the accompanying drawings.

FIG. 1 is a block diagram showing the cooperation of exemplary components of another illustrative implementation in accordance with some embodiments.

FIG. 2 is a block diagram showing an illustrative block representation of an illustrative system in accordance with some embodiments.

FIG. 3 is a block diagram describing the interaction of various parties of an exemplary referral environment in accordance with some embodiments.

FIG. 4 is a block diagram of the search space of an exemplary referral environment in accordance with some embodiments.

FIG. 5 is a flow diagram showing illustrative processing performed in generating referrals in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Currently, a person seeking to locate information to assist in a decision, to determine an affinity, and/or identify a dislike can leverage traditional non-electronic data sources (e.g., personal recommendations—which can be few and can be biased) and/or electronic data sources such as web sites, bulletin boards, blogs, and other sources to locate (sometimes rated) data about a particular topic/subject (e.g., where to stay when visiting San Francisco). Such an approach is time consuming and often unreliable as with most of the electronic data there lacks an indicia of trustworthiness of the source of the information. Failing to find a plethora (or spot on) information from immediate non-electronic and/or electronic data source(s), the person making the inquiry is left to make the decision using limited information, which can lead to less than perfect predictions of outcomes, results, and can lead to low levels of satisfaction undertaking one or more activities for which information was sought.

Current practices also do not leverage trustworthiness of information or, stated differently, attribute a value to the reputation of the source of data (e.g., referral). With current practices, the entity seeking the data must make a value judgment on the reputation of the data source. Such value judgment is generally based on previous experiences with the data source (e.g., rely on Mike's restaurant recommendations as he is a chef and Laura's hotel recommendations in Europe as she lived and worked in Europe for 5 years). Unless the person making the inquiry has an extensive network of references from which to rely to obtain desired data needed to make a decision, most often, the person making the decision is left to take a risk or “roll the dice” based on best available non-attributed (non-reputed) data. Such a prospect often leads certain participants from not engaging in a contemplated activity.

Reputation accrued by persons in such a network of references are subjective. In other words, reputation accrued by persons in such a network of references appear differently to each other person in the network, as each person's opinion is formed by their own individual networks of trust.

Real world trust networks follow a small-world pattern, that is, where everyone is not connected to everyone else directly, but most people are connected to most other people through a relatively small number of intermediaries or “connectors”. Accordingly, this means that some individuals within the network may disproportionately influence the opinion held by other individuals. In other words, some people's opinions may be more influential than other people's opinions.

In some embodiments, augmenting reputation, which may be subjective, influence can be an objective measure that can be useful in filtering opinions, information, and data.

It will be appreciated that reputation and influence provide unique advantages in accordance with some embodiments for the ranking of individuals or products or services of any type in any form.

In some embodiments, techniques are provided allowing for the use of reputation scores and influence scores to determine whether or not a transaction between individual entities in a given network should take place; under what constraints; at what price; and with what proportion of the price being retained by the entity implementing these systems and methods; in which the individual entities can be natural or legal persons, or other entities such as computational processes, documents, data files, or any form of product or service or information of any form for which a representation has been made within the computer network within this system. The various embodiments described herein provide that the influence and reputation can be estimated using any appropriate technique, including but not limited to, for example, the various techniques described herein.

In some embodiments, techniques described herein include the use of reputation scores and influence scores to determine whether or not a transaction between individual entities in a given network should take place. In various embodiments, aspects of which can be combined to create further illustrative implementations, the use of reputation and influence scores is used to determine under what constraints a transaction between individual entities should take place; at what price; and with what proportion of the price being retained by the entity implementing these techniques. In some embodiments, the individual entities can be natural or legal persons, or other entities such as computational processes, documents, data files, or any form of product or service or information of any form for which a representation has been made within the computer network within this system. In some embodiments, the measures of influence and reputation are on dimensions that may but need not be related to a specific topic (e.g., automobiles or restaurants), or source (e.g., a weblog or Wikipedia entry or news article or Twitter feed). In some embodiments, the measures of influence and/or reputation of at least one individual entity are used to determine whether a transaction between that and at least one other individual entity takes place or not. In some embodiments, the measures of influence or reputation for each individual or group of individual entities are used to determine at least in part the price that other individual entities pay for a transaction of any sort with the individual or group of individual entities. In some embodiments, revenue is shared between any individual entity or group of individual entities and the provider of the service, in a proportion related to the level of directly measured influence or reputation of the entity or entities.

In some embodiments, a social graph of individuals (e.g., users) on the Internet is generated and/or received, in which the individuals represents natural or legal persons and the documents represents natural or legal persons, or other entities, such as computational processes, documents, data files, or any form of product or service or information of any form for which a representation has been made within the computer network within this system.

In some embodiments, the social graph is directed (e.g., a directed graph) or undirected (e.g., an undirected graph).

In some embodiments, the social graph is explicit, with individuals expressing a link to other individuals; or implicit, with techniques for identifying the links between individuals, for example, trust, respect, and/or positive or negative opinion.

In some embodiments, the links or edges on the graph represent different forms of association including friendship, trust, and/or acquaintance, and the edges on the graph can be constrained by dimensions representing ad-hoc types including but not limited to subjects, fields of interest, and/or search terms.

In some embodiments, nodes of the graph represent or correspond to people (e.g., users) or other entities (e.g. web pages, blogs, etc) that may have expressions of opinion, reviews, or other information useful for the estimation of influence, and each node on the graph is viewed as an influential entity, for example, once influence for that node has been estimated.

In some embodiments, the decision to allow complete or partial access to opinions or expressions of given influential entities is made at least in part based on any complete or partial combination of the measure of influence of the entity, the expressed intent of the entity, the measure of influence of the entity seeking complete or partial access, and a price to be paid for such access.

In some embodiments, a price to be paid in order to allow complete or partial access to opinions or expressions of given influential entities is determined at least in part based on any complete or partial combination of the measure of influence of the entity, the expressed intent of the entity, and the measure of influence of the entity seeking complete or partial access.

In some embodiments, a proportion of revenue received for allowing complete or partial access to opinions or expressions of given influential entities is shared with the influential entity, with the proportion of revenue being determined at least in part based on any complete or partial combination of the measure of influence of the entity, the expressed intent of the entity, the measure of influence of the entity seeking complete or partial access, and the revenue received.

In some embodiments, complete or partial access to documents, products, services, in any form or through any technique as can be represented within the network as an entity with an estimated reputation score is made at least in part based on any complete or partial combination of the measure of reputation of the entity, the measure of influence and/or reputation of the entity seeking complete or partial access, and a price to be paid for such access; in which such access can, for example, refer to purchase, lease, loan, acquisition or any other form of access in any form as appropriate.

In some embodiments, a price to be paid in order to allow complete or partial access to documents, products, services, in any form or through any technique as represented within the network as an entity with an estimated reputation score is made at least in part based on any complete or partial combination of the measure of reputation of the entity, the measure of influence and/or reputation of the entity seeking complete or partial access, and a price to be paid for such access; in which such access can, for example, refer to purchase, lease, loan, acquisition or any other form of access in any form as appropriate.

In some embodiments, a proportion of revenue received for allowing complete or partial access to documents, products, services, in any form or through any technique as represented within the network as an entity with an estimated reputation score is shared with an entity or group of entities whose opinions or expressions have influenced the calculation of the reputation score, with the proportion of revenue being determined at least in part based on any complete or partial combination of the measure of reputation of the entity, the measure of influence and/or reputation of the entity seeking complete or partial access, the measure of influence and/or reputation of the entity or group of entities with whom revenue may be shared, the degree to which the opinions and expressions of the entity or group of entities with whom revenue may be shared have influenced the calculation of the reputation score, and the revenue received; such access can, for example, refer to purchase, lease, loan, acquisition or any other form of access in any form as appropriate.

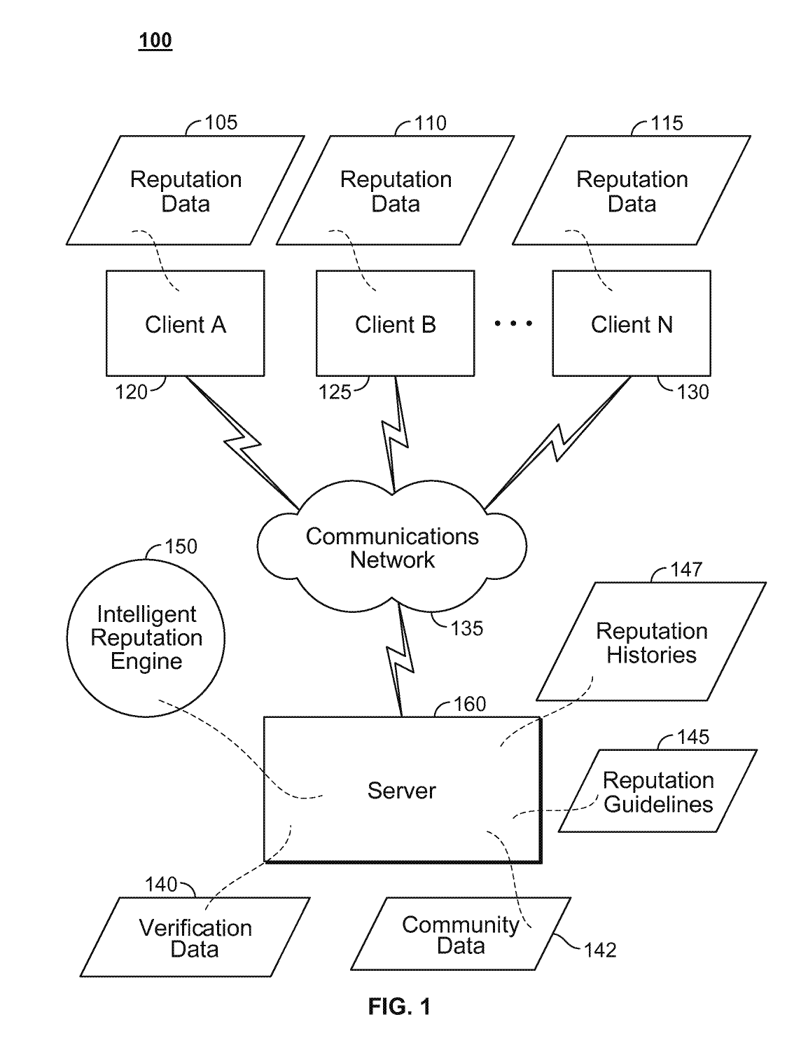

FIG. 1 is a block diagram showing the cooperation of exemplary components of another illustrative implementation in accordance with some embodiments. In particular, FIG. 1 shows an illustrative implementation of exemplary reputation attribution platform 100 in accordance with some embodiments. As shown in FIG. 1, exemplary reputation attribution platform 100 includes client computing environment 120, client computing environment 125 up to and including client computing environment 130, communications network 135, server computing environment 160, intelligent reputation engine 150, verification data 140, community data 142, reputation guidelines 145, and reputation histories data 147. Also, as shown in FIG. 1, exemplary reputation attribution platform 100 includes a plurality of reputation data (e.g., inputted and/or generated reputation data) 105, 110, and 115 which can be displayed, viewed, stored, electronically transmitted, navigated, manipulated, stored, and printed from client computing environments 120, 125, and 130, respectively.

In some embodiments, in an illustrative operation, client computing environments 120, 125, and 130 can communicate and cooperate with server computing environment 160 over communications network 135 to provide requests for and receive reputation data 105, 110, and 115. In the illustrative operation, intelligent reputation engine 150 can operate on server computing environment 160 to provide one or more instructions to server computing environment 160 to process requests for reputation data 105, 110, and 115 and to electronically communicate reputation data 105, 110, and 115 to the requesting client computing environment (e.g., client computing environment 120, client computing environment 125, or client computing environment 130). As part of processing requests for reputation data 105, 110, and 115, intelligent reputation engine 150 can utilize a plurality of data comprising verification data 140, community data 142, reputation guidelines 145, and/or reputation histories data 147. Also, as shown in FIG. 1, client computing environments 120, 125, and 130 are capable of processing content production/sharing data 105, 110, and 115 for display and interaction to one or more participating users (not shown).

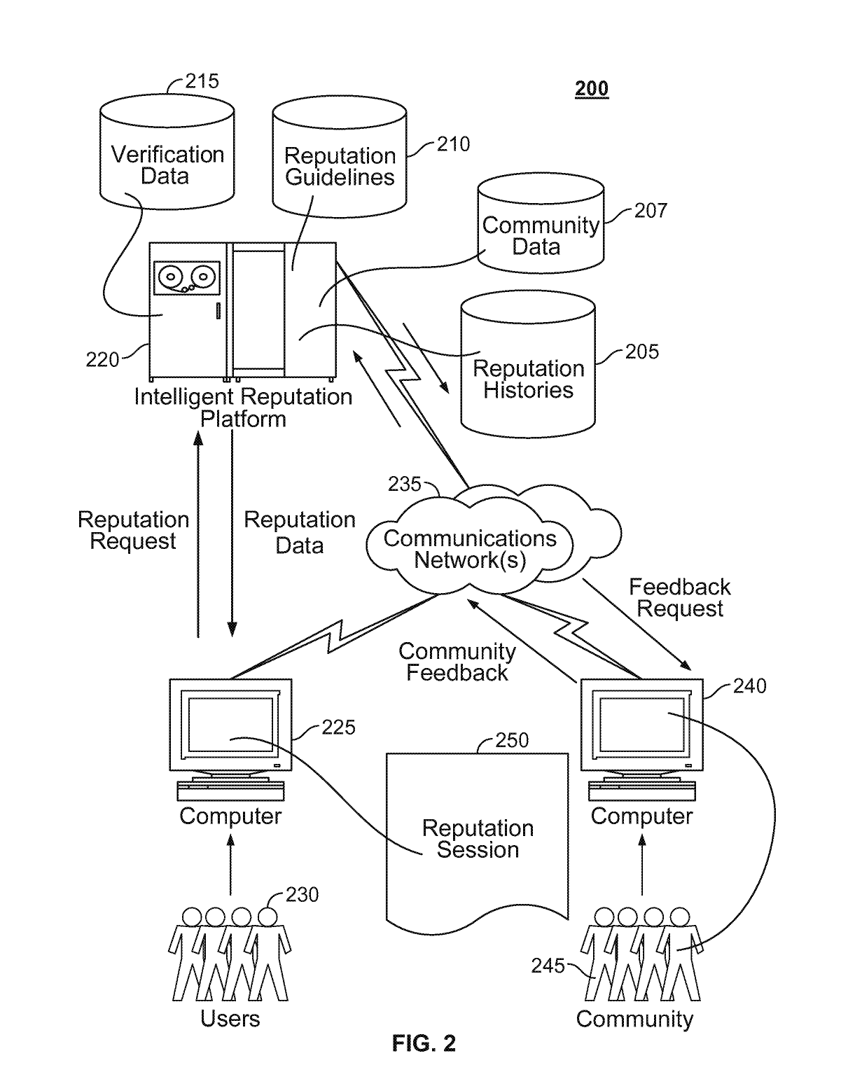

FIG. 2 is a block diagram showing an illustrative block representation of an illustrative system in accordance with some embodiments. In particular, FIG. 2 shows a detailed illustrative implementation of exemplary reputation attribution environment 200 in accordance with some embodiments. As shown in FIG. 2, exemplary content reputation attribution environment 200 includes intelligent reputation platform 220, verification data store 215, reputation guidelines data store 210, reputation histories data store 205, community data store 207, user computing environment 225, reputation targets (e.g., users) 230, community computing environment 240, and community 245. Additionally, as shown in FIG. 2, reputation attribution environment 200 includes reputation session content 250, which can be displayed, viewed, transmitted and/or printed from user computing environment 225 and/or community computing environment 240.

In some embodiments, in an illustrative implementation, intelligent reputation platform 220 can be electronically coupled to user computing environment 225 and community computing environment 240 via communications network 235. In some embodiments, communications network 235 includes fixed-wire (e.g., wire line) and/or wireless intranets, extranets, and/or the Internet.

In some embodiments, in an illustrative operation, users 230 can interact with a reputation data interface (not shown) operating on user computing environment 225 to provide requests to initiate a reputation session that are passed across communications network 235 to intelligent reputation platform 220. In the illustrative operation, intelligent reputation platform 220 can process requests for a reputation session and cooperate with interactive verification data store 215, reputation guidelines data store 210, reputation histories data store 205, and community data store 207 to generate a reputation session for use by users 230 and community 245.

In some embodiments, in an illustrative implementation, verification data store 215 can include data representative of connections between users 230 and community members 245. Such data can include but is not limited to connections between users to identify a degree of association for use in generation of reputation data. In the illustrative implementation, reputation guideline data store 210 can include data representative of one or more rules for attributing reputations amongst users 230 and community 245. Reputation histories data store 205 can include one or more generated reputation attributions for use as part of reputation data processing. Community data store 207 can include data representative of community feedback for generated reputation data. For example, the data representative of connections can be provided through user input or generated from any number of techniques including but not limited to automated or computer-assisted processing of data available on computer networks, links expressed or implied between entities on social networking websites, user commentary or “blogging” websites, or any other form of document available on the Internet.

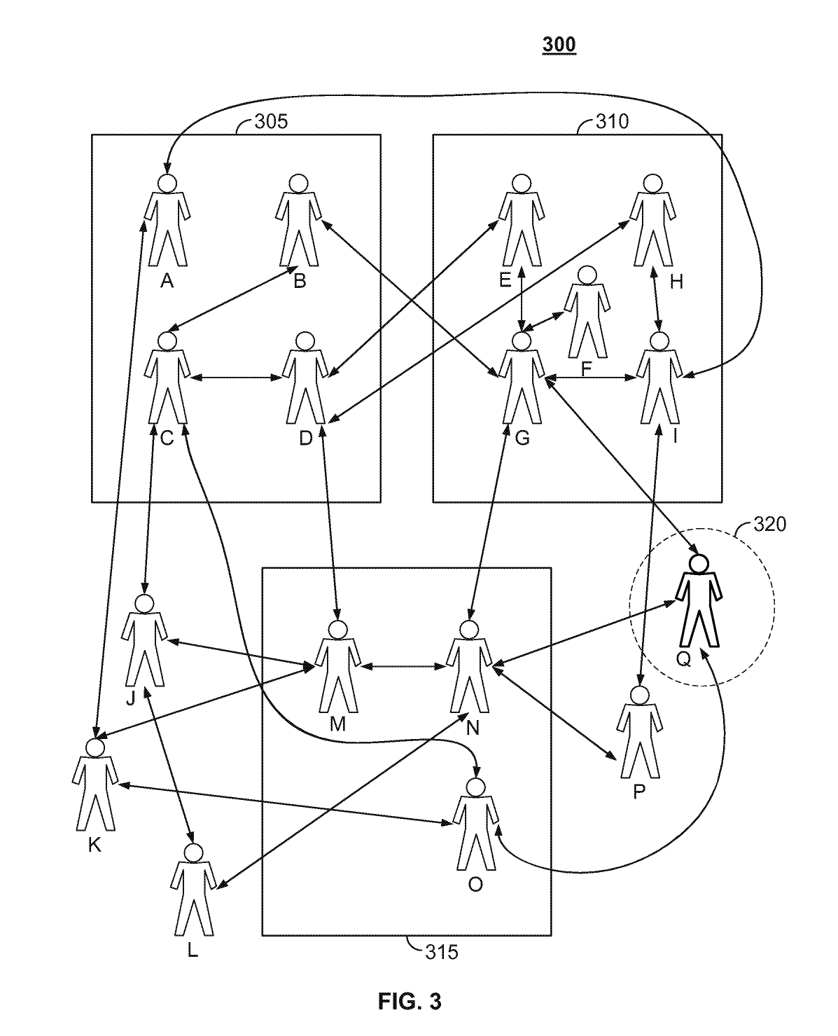

FIG. 3 is a block diagram describing the interaction of various parties of an exemplary referral environment in accordance with some embodiments. In particular, FIG. 3 shows contributing elements of exemplary reputation attribution environment 300 in accordance with some embodiments. As shown, exemplary reputation attribution environment 300 comprises a plurality of sub-environments 305, 310, and 315 and numerous reputation targets A-Q. As shown, reputation targets can have direct and/or indirect connections with other reputations targets within a given sub-environment 305, 310, or 315 and/or with other reputation targets that are outside sub-environments 305, 310, 315.

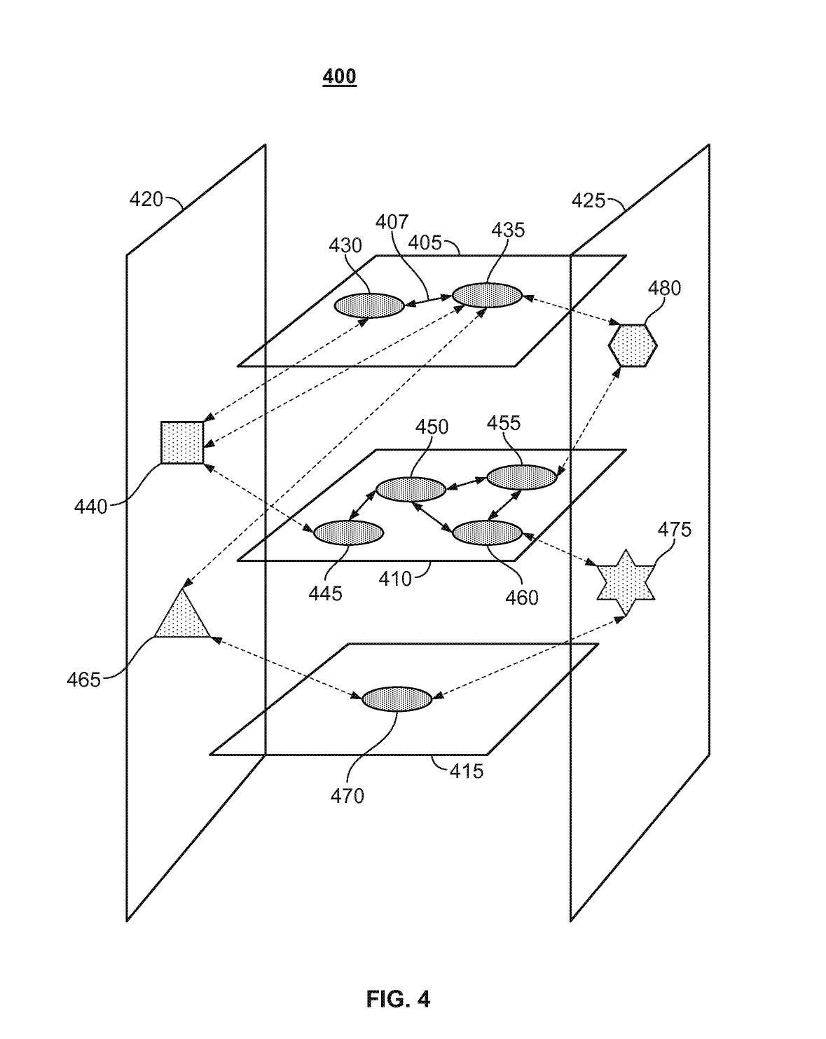

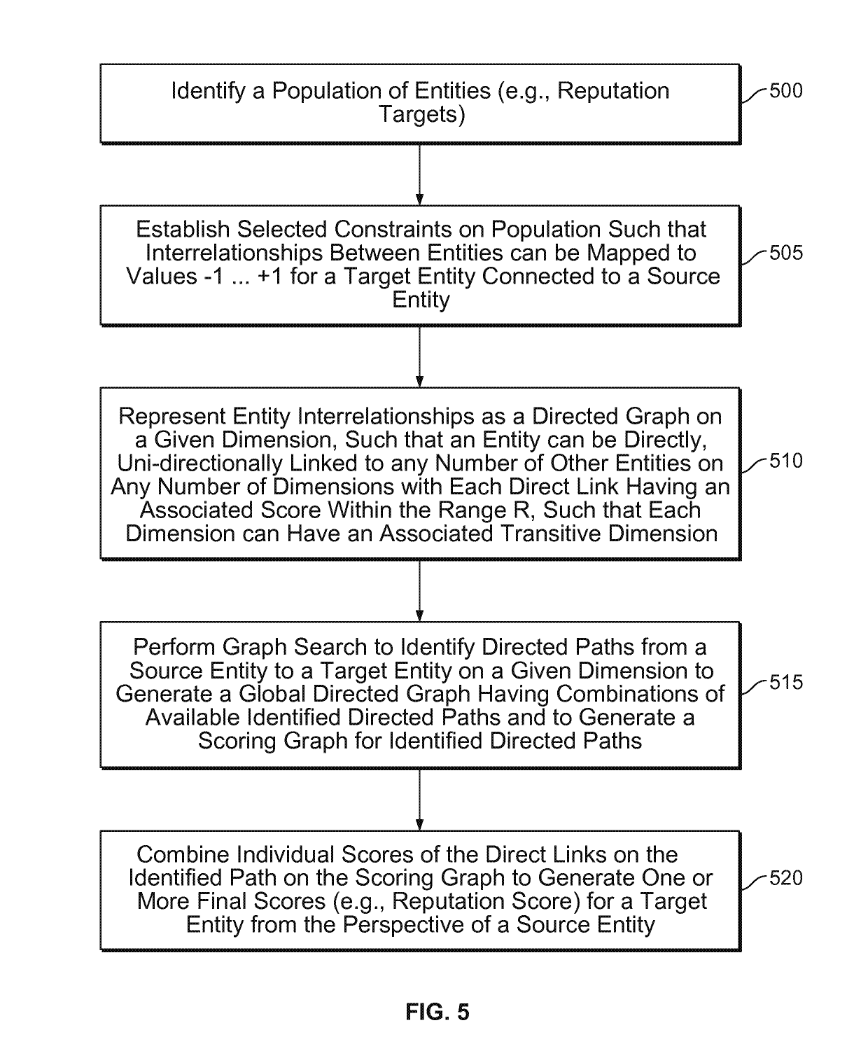

In some embodiments, in an illustrative implementation, sub-environments 305, 310, or 315 can represent one or more facets of a reputation target's experience, such as work, home, school, club(s), and/or church/temple/commune. In the illustrative implementation, an exemplary reputation target Q can inquire about the reputation of other reputation targets (e.g., obtain trusted data for use to assist in making a decision, determine an affinity, and/or identify a dislike). The individual reputations of each of the target participants can be derived according to the herein described techniques (e.g., in FIGS. 4 and 5) so that each reputation target is attributed one or more reputation indicators (e.g., a reputation score associated for restaurant referrals, another reputation score associated for movie referrals, another reputation score associated for match-making, etc.). The reputation indicators can be calculated based on the degree and number of relationships between reputation targets in a given sub-environment and/or outside of a sub-environment. Once calculated, an exemplary reputation target Q can query other reputation targets for trusted data (e.g., recommendations and/or referrals) and can process such trusted data according to reputation score of the data source (e.g., reputation target).

For example, sub-environment 305 can represent a place of business, sub-environment 310 can represent home, and sub-environment can represent a country club. In some embodiments, in an illustrative operation, each of the reputation targets of reputation attribution environment 300 can be attributed one or more reputation scores (e.g., reputation score for business data, reputation score for family data, etc.). In the illustrative operation, the reputation score for each reputation target for each category (e.g., business, family, social, religious, etc.) can be calculated according to the degree of relationship with other reputation targets and/or the number of connections with other relationship targets.

In some embodiments, in the illustrative operation, reputation target Q can request data regarding a business problem (e.g., how to broker a transaction). Responsive to the request, the reputation targets of sub-environment 305 (e.g., reputation target can act as data sources for reputation target Q) providing data that can satisfy reputation target Q's request. Additionally, other reputation targets, who are not directly part of sub-environment 305, can also act as data sources to reputation target Q. In this context, the reputation score for reputation targets A, B, C, and/or D) can have a higher reputation score than other reputation targets not part of sub-environment 305 as such reputation targets are within sub-environment 305, which is focused on business. In the illustrative operation, other reputation targets not part of sub-environment 305 can have equal or near level reputation scores to reputation targets (A, B, C, and/or D) of sub-environment 305 based on the connections with reputation targets A, B, C, and/or D and reputation target Q. For example, as shown in FIG. 3, reputation target I can have a relatively high reputation score as it pertains to business as reputation target I has a number of direct and indirect connections (I-A, I-G-B, I-H-D, I-G-E-D) to reputation targets (e.g., A, B, C, and/or D) of sub-environment 305 and to inquiring reputation target Q.

It is appreciated that although exemplary reputation attribution environment 300 of FIG. 3 is shown have a configuration of sub-environments having various participants, that such description is merely illustrative the contemplated reputation attribution environment of the herein described systems and methods can have numerous sub-environments with various participants in various non-described configurations.

FIG. 4 is a block diagram of the search space of an exemplary referral environment in accordance with some embodiments. In particular, FIG. 4 shows exemplary reputation scoring environment 400 in accordance with some embodiments. As shown in FIG. 4, reputation scoring environment 400 includes a plurality of dimensions 405, 410, and 415, which are operatively coupled to one or more transitive dimensions 420 and 425. Further, as shown, reputation scoring environment 400 includes one or more entities 430, 435, 445, 450, 460, and 470 residing on one or more of dimensions 405, 410, and 415 as well as transitive connectors 440, 465, 470, and 480 residing on transitive dimensions 420 and 425.

In some embodiments, in an illustrative operation, scores for one or more entities 430, 435, 445, 450, 460 and/or 470 can be determined on a network (not shown) on a given dimension 405, 410 and/or 415. In the illustrative operation, an entity 430, 435, 445, 450, 460 and/or 470 can be directly linked to any number of other entities 430, 435, 445, 450, 460 and/or 470 on any number of dimensions 405, 410, and/or 415 (e.g., such that each link, direct or indirect link, can be associated with a score). For example, one or more dimension 405, 410, and/or 415 can have an associated one or more transitive dimension 420 and/or 425.

In the illustrative operation, a directed path 407 on a given dimension 405 between two entities 430 and 435, a source and a target, includes a directed link from the source entity 430 (e.g., illustratively 430 as all entities 430, 435, 445, 450, 460, and/or 470 can be source and/or target entities depending on the perspective of the scoring attribution platform as described herein in accordance with various embodiments) to an intermediate entity 440, prefixed to a directed path from the intermediate entity 440 to the target entity 435.

In some embodiments, in an illustrative implementation, links on the path can be on one or more transitive dimensions 420 and/or 425 associated with a given dimension 405, 410, and/or 415. For example, to determine a score on a given dimension 405, 410, and/or 415 between a source entity 430 and a target entity 435, directed paths 407 on the given dimension 405, 410, and/or 415 can be determined through any kind of graph search (not shown). In the illustrative operation, the individual scores on the one or more links on the one or more paths can be combined to produce one or more resulting scores using various techniques for propagating scores and for resolving conflicts between different scores. For example, one or more intermediate entities 440, 465, 470, and/or 480 can also be provided with a measure of influence on the dimensions 405, 410 and/or 415 based on the universe of source entities (e.g., 430, 435, 445, 450, 460, 470), the universe of target entities (e.g., 430, 435, 445, 450, 460, 470) and the links between them.

It is appreciated that although reputation scoring environment 400 is shown to have a particular configuration operating to an illustrative operation with a particular number of dimensions, transitive dimensions, entities, direct connections and indirect connections that such description is merely illustrative as the influence calculation within the herein described techniques can employ various dimensions, transitive dimensions, entities, direct, and/or indirect connections having various configurations and assemblages operating according to other illustrative operations.

FIG. 5 is a flow diagram showing illustrative processing performed in generating referrals in accordance with some embodiments. In particular, FIG. 5 shows exemplary processing in calculating reputations scores in accordance with some embodiments. As shown in FIG. 5, processing begins at block 500 at which a population of entities are identified. From there processing proceeds to block 505 at which selected constraints are established on the identified population such that the interrelationships between the entities can be mapped to values −1 to +1 for a target entity connected to source entity. Processing then proceeds to block 510 at which entity relationships are represented as a directed graph on a given dimension such that an entity can be directly, uni-directionally linked to any number of other entities on any number of dimensions with each direct link having an associated score within a selected range R such that each dimension can have therewith an associated transitive dimension. From there, processing proceeds to block 515 at which a graph search is performed to identify directed paths from a source entity to a target entity on a given dimension to generate a global directed graph having combinations of available identified directed paths and to generate a scoring graph for identified directed paths. Processing then proceeds to block 520 at which individual scores of the direct links on an identified path can be combined to generate one or more final scores (e.g., reputation score) for a target entity from the perspective of a source entity.

In some embodiments, in an illustrative implementation, the processing of FIG. 5 can be performed such that for a population of entities, a method of determining scores, each within the range R which can be mapped to the values −1 . . . +1, for a target entity connected to a source entity on a network that can be conceptually represented as a directed graph on each given dimension, such that an entity can be directly, uni-directionally linked to any number of other entities on any number of dimensions, with each direct link having an associated score within the range R. Further, each dimension can have an associated transitive dimension and such that a directed path on a given dimension between two entities, a source entity and a target entity, can be defined as a direct link from the source entity to an intermediate entity, prefixed to a directed path from the intermediate entity to the target entity, subject to the selected constraints including but not limited to: 1) a direct link from any entity to the target entity must be on the given dimension, and 2) a direct link on the path from any entity to an intermediate entity that is not the target entity must be either on the transitive dimension associated with the given dimension, or on the given dimension itself if the given dimension is itself is a transitive dimension.

Furthermore, in the illustrative operation, the processing of FIG. 5 can include but is not limited to: (A) performing a graph search (e.g., using various graph search techniques) to identify directed paths from a source entity to a target entity on a given dimension subject to the above definition of a directed path that, for example, optimally results in a directed graph combining all such identified directed paths. The resulting directed graph, for example, provides a scoring graph that can be stored separately. In the illustrative operation, individual scores can be combined (B) on each direct link on each path on the scoring graph to produce one or more final scores, with or without an associated set of confidence values in the range C=0 . . . 1 for each resulting score, for the target entity from the perspective of the source entity. In the illustrative operation, the acts (A) and (B) can be performed, for example, in sequence, or performed simultaneously; when performed simultaneously, the combination of individual scores described in act (B) being performed during the graph search described in act (A) without the creation of separately stored scoring graph; and wherein the graph search performed in act (A) can be optimized by some combination of scores identified through act (B) such that the optimization may result in the exclusion of certain paths between the source entity and the target entity.

In some embodiments, the influence of each entity is estimated as the count of other entities with direct links to the entity or with a path, possibly with a predefined maximum length, to the entity; with or without the count being adjusted by the possible weights on each link, the length of each path, and the level of each entity on each path.

In some embodiments, the influence of each entity is estimated with the adjusted count calculated through the operations described herein, transformed into a rank or percentile relative to the similarly measured influence of all other entities.

In some embodiments, the influence of each entity is estimated as the count of actual requests for data, opinion, or searches relating to or originating from other entities, entities with direct links to the entity or with a path, possibly with a predefined maximum length, to the entity; such actual requests being counted if they result in the use of the paths originating from the entity (e.g., representing opinions, reviews, citations or other forms of expression) with or without the count being adjusted by the possible weights on each link, the length of each path, and the level of each entity on each path.

In some embodiments, the influence of each entity is estimated with the adjusted count calculated through the operations described herein, transformed into a rank or percentile relative to the similarly measured influence of all other entities.

In some embodiments, the influence of each entity is estimated as the count of actual requests for data, opinion, or searches relating to or originating from other entities, entities with direct links to the entity or with a path, possibly with a predefined maximum length, to the entity; such actual requests being counted if they occur within a predefined period of time and result in the use of the paths originating from the entity (e.g., representing opinions, reviews, citations or other forms of expression) with or without the count being adjusted by the possible weights on each link, the length of each path, and the level of each entity on each path.

In some embodiments, the influence score is weighted by an expertise score for each subject based on descriptive criteria. In some embodiments, the influence score is weighted by an expertise score for each subject based on descriptive criteria, in which the expertise score for each subject is based on the citations from each subject matching descriptive criteria as a relative share of all citations from the subject, and citations from all subjects matching the descriptive criteria as a relative share of citations from all subjects.

In some embodiments, the influence of each entity is estimated by applying to it any of several graph metric functions, such as centrality or betweenness, in which the functions, such as centrality or betweenness, is estimated either by relating the entity to the entire graph comprising all linked entities, or by relating the entity to a subgraph comprising all entities linked to the entities directly or by paths of up to a given length.

In some embodiments, the illustrative operations described herein for the calculation of influence is performed for each dimension separately, resulting in one influence measure for each entity for each dimension; for all dimensions together, resulting in one influence measure for each entity; or for any given subgroup of dimensions together applied to any given entity, resulting in each entity having as many influence measures as the number of subgroups of dimensions applied to that entity.

In some embodiments, the influence of each entity as estimated in each of the operations described herein, is adjusted by metrics relating to the graph including all entities or a subset of all linked entities. For example, such metrics can include the density of the graph, defined as the ratio of the number of links to the number of linked entities in the graph; such metrics are transformed by mathematical functions optimal to the topology of the graph, especially, for example, in which it is known that the distribution of links among entities in a given graph may be non-linear. An example of such an adjustment would be the operation of estimating the influence of an entity as the number of directed links connecting to the entity, divided by the logarithm of the density of the graph comprising all linked entities. For example, such an operation may provide an optimal method of estimating influence rapidly with a limited degree of computational complexity.

In some embodiments, in which the influence of entities as estimated in each of the operations described herein is estimated for separate, unconnected graphs; and n which such influence estimated for entities in separate, unconnected graphs is adjusted by applying metrics relating to each separate unconnected graph in its entirety, as described herein; the influence of each entity on one graph, thus adjusted, is normalized and compared to the influence of another entity on another graph, also thus adjusted. For example, such an operation allows for the use of influence measures across separate, unconnected graphs.

In some embodiments, the estimation of influence is optimized for different contexts and requirements of performance, memory, graph topology, number of entities, and/or any other requirements or criteria, by any combination of the operations described herein, and any similar operations involving metrics including but not limited to values including the following: the number of potential source entities to the entity for which influence is to be estimated, the number of potential target entities, the number of potential directed paths between any one entity and any other entity on any or all given dimensions, the number of potential directed paths that include the entity, and/or the number of times within a defined period that a directed link from the entity is used for a scoring, search, or other operation(s).

It is understood that the herein described systems and methods are susceptible to various modifications and alternative constructions. There is no intention to limit the herein described techniques to the specific constructions described herein. On the contrary, the herein described techniques are intended to cover all modifications, alternative constructions, and equivalents falling within the scope and spirit of the herein described techniques.

It should also be noted that the herein described techniques can be implemented in a variety of electronic environments (e.g., including both non-wireless and wireless computer environments, including cell phones and video phones), partial computing environments, and real world environments. For example, the various techniques described herein can be implemented in hardware or software, or a combination of both. In some embodiments, the techniques are implemented in computing environments maintaining programmable computers that include a computer network, processor, servers, and a storage medium readable by the processor (e.g., including volatile and non-volatile memory and/or storage elements), at least one input device, and at least one output device. Computing hardware logic cooperating with various instructions sets are applied to data to perform the functions described herein and to generate output information. The output information is applied to one or more output devices. Programs used by the exemplary computing hardware can be implemented in various programming languages, including high level procedural or object oriented programming language to communicate with a computer system. In some embodiments, the herein described techniques can be implemented in assembly or machine language, if desired. In any case, the language can be a compiled or interpreted language. For example, each such computer program can be stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, in which the storage medium so configured causes a computer to operate in a specific and predefined manner.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining an influence score for a first subject, wherein the first subject requested a transaction; and
determining approval of the transaction based on criteria including the influence score of the first subject.

2. The method recited in claim 1, wherein the first subject corresponds to a user.

3. The method recited in claim 1, wherein the influence score is directly estimated.

4. The method recited in claim 1, wherein the influence score is a directly estimated objective measure of influence.

5. The method recited in claim 1, wherein the influence score is based on a first dimension.

6. The method recited in claim 1, wherein the influence score is based on a first dimension, and wherein the transaction is based on the first dimension.

7. The method recited in claim 1, wherein the influence score is weighted by an expertise score for each subject based on descriptive criteria.

8. The method recited in claim 1, wherein the influence score is weighted by an expertise score for each subject based on descriptive criteria, wherein the expertise score for each subject is based on the citations from each subject matching descriptive criteria as a relative share of all citations from the subject, and citations from all subjects matching the descriptive criteria as a relative share of citations from all subjects.

9. The method recited in claim 1, wherein the transaction includes one or more of the following: a product, and a service.

10. The method recited in claim 1, wherein the transaction includes allowing complete or partial access to content.

11. The method recited in claim 1, further comprising:
determining a pricing of the transaction based on criteria including the influence score of the first subject.

12. The method recited in claim 1, further comprising:
sharing transactional revenue for the transaction with the first subject based on criteria including the influence score of the first subject.

13. The method recited in claim 1, further comprising:
determining pricing of the transaction based on criteria including the influence score of the first subject; and
sharing transactional revenue for the transaction with the first subject based on criteria including the influence score of the first subject.

14. The method recited in claim 1, further comprising:
determining an influence score for a second subject, wherein the second subject is a potential participant in the transaction.

15. The method recited in claim 1, further comprising:
determining an influence score for a second subject, wherein the second subject is a potential participant in the transaction;
determining pricing of the transaction based on criteria including the influence score of the first subject and/or the second subject; and
sharing transactional revenue with the second subject based on criteria including the influence score of the second subject, wherein the second subject is determined to have a higher influence score than the first subject on a first dimension,
wherein the influence scores for each subject can be weighted by expertise scores for each subject based on descriptive criteria.

16. The method recited in claim 1, further comprising:
determining an influence score for a plurality of subjects, wherein each of the plurality of subjects is a potential participant in the transaction.

17. The method recited in claim 1, further comprising:
determining a first influence score for each of a plurality of subjects for a first transaction, wherein the first transaction is associated with a first dimension; and
determining a second influence score for each of the plurality of subjects for a second transaction, wherein the second transaction is associated with a second dimension.

18. The method recited in claim 1, further comprising:
determining a first influence score for each of a plurality of subjects for a first transaction, wherein the first transaction is associated with a first dimension; and
determining a second influence score for each of the plurality of subjects for a second transaction, wherein the second transaction is associated with a second dimension,
wherein the first dimension and the second dimension are the same dimension.

19. A system, comprising:
a processor configured to:
determine an influence score for each of a plurality of subjects, wherein each of the plurality of subjects is a potential participant in a transaction, and wherein the influence score is directly estimated; and
determine potential pricing of the transaction based on criteria including the influence score of potential participants in the transaction, wherein the potential participants in the transaction are at least a subset of the plurality of subjects; and
a memory coupled to the processor and configured to provide the processor with instructions.

20. The system recited in claim 19, wherein the processor is further configured to:
determine approval and actual pricing of the transaction based on criteria including the influence score of actual participants in the transaction, wherein the actual participants in the transaction are at least a subset of the potential participants in the transaction; and
share transactional revenue with a subset of the actual participants in the transaction based on criteria including the influence score of each of the subset of the actual participants in the transaction.

21. A computer program product, the computer program product being embodied in a computer readable storage medium and comprising computer instructions for:
determining an influence score for each of a plurality of subjects, wherein each of the plurality of subjects is a potential participant in a transaction, wherein the influence score is a directly estimated objective measure of influence; and
determining approval for participation in the transaction and pricing of the transaction based on criteria including the influence score of each of the requesting participants on a first dimension, wherein the requesting participants requested to participate in the transaction, wherein the requesting participants is at least a subset of the plurality of subjects, and wherein the transaction is associated with the first dimension.

22. The computer program product recited in claim 21, further comprising computer instructions for:
sharing transactional revenue at a first proportion with a first subject based on criteria including the influence score of the first subject on the first dimension; and
sharing advertising revenue at a second proportion with a second subject based on criteria including the influence score of the second subject on the first dimension,
wherein the first subject and the second subject are actual participants in the transaction, wherein the first subject is determined to have a higher influence score than the second subject, and wherein the first proportion is greater than the second proportion.
